(19) United States
(12) Patent Application Publication
(10) Pub. No.: US 2026/0209080 A1
(43) Pub. Date: Jul. 23, 2026

(54) WATER FILTRATION ASSEMBLY AND METHODS OF ASSEMBLING THE SAME

(71) Applicant: Haier US Appliance Solutions, Inc., Wilmington, DE (US)

(72) Inventors: Thomas Earl Mckeehan, JR., Crestwood, KY (US); Gregory Sergeevich Chernov, Louisville, KY (US)

(21) Appl. No.: 19/026,860

(22) Filed: Jan. 17, 2025

(51) Int. Cl. C02F 1/32; C02F 1/28; C02F 1/42; C02F 1/44; C02F 101/32; C02F 101/36; C02F 103/34; F25D 17/02

(52) U.S. Cl. CPC C02F 1/325; C02F 1/281; C02F 1/283; C02F 1/42; C02F 1/44; F25D 17/02; C02F 2101/322; C02F 2101/36; C02F 2103/343; C02F 2201/3222; C02F 2303/04

(57) ABSTRACT

A water filtration assembly may include a filtration housing. The filtration housing may include an end cap. The water filtration assembly may include an electronic module disposed within the filtration housing. The water filtration assembly may include an internal component disposed within the filtration housing. The electronic module may be mounted to the internal component. The end cap may be overmolded over the electronic module and the internal component. A portion of the electronic module is embedded within the end cap.

### FIELD OF THE DISCLOSURE

The present subject matter relates generally to a water filtration assembly, and more particularly to methods of assembling the same.

### BACKGROUND OF THE DISCLOSURE

Fresh water is a limited resource on the earth. Water shortage and contamination are among the top current issues in public health. With an increase in drinking water contaminant levels and the emergence of new contaminants, improvements in chemical and microbiological reduction performance of end point water treatment systems are desired to ensure consumer protection from potentially harmful exposure.

Water treatment using adsorptive media has been in practice since ancient times. Although modern Activated Carbon-based (AC) technologies allow the reduction of multiple health-related contaminants, the further significant improvement of contaminant reduction performance is challenging. In most cases, an improvement of contaminant reduction performance requires an increase of physical dimensions of the product (a limiting factor for many residential applications), or a reduction of effective pore size (pore size reduction demands higher feed pressures or lowers flow rates which are also limiting factors for most residential applications). For most AC-based systems, the microbiological reduction is limited to relatively large protozoa and most of these systems provide no protection from harmful bacteria and viruses.

Water treatment using germicidal ultraviolet (UV) radiation has also been practiced for several decades. Although UV treatment can provide significant levels of microbiological reduction, it has several disadvantages. For example, UV treatment requires direct line of sight, and to be effective, the treated water must be optically clear and contain no particulates. UV provides some levels of reduction for additional contaminants, but these levels are inferior to the reduction level granted by many alternative water treatment methods.

Systems combining AC modules and ultraviolet-C (UVC) modules are currently being produced. Although these systems combine the benefits and mitigate the disadvantages of both technologies used separately, challenges exist related to providing power to power consuming components within the system. For example, sealing electrical components (e.g., circuit boards, sensors, or the like) within the system (e.g., from water) can be mechanically complex and the current manufacturing processes are costly.

Accordingly, systems and methods for manufacturing electronics inside water treatment systems would be beneficial.

### BRIEF DESCRIPTION OF THE DISCLOSURE

Aspects and advantages of the invention will be set forth in part in the following description, or may be obvious from the description, or may be learned through practice of the invention.

In one exemplary aspect of the present disclosure, a water filtration assembly for an appliance is provided. The water filtration assembly may include a filtration housing. The water filtration assembly may include an end cap assembly secured to the filtration housing. The end cap assembly may include an electromagnetic radiation module. The electromagnetic radiation module may include an electromagnetic radiation source. The end cap assembly may include a top plate. The electromagnetic radiation module may be mounted to the top plate. The top plate may include a light housing. The light housing may define a light opening. The electromagnetic radiation source may be positioned within the light opening. The end cap assembly may include a housing disposed over the electromagnetic radiation module and the top plate. A portion of the electromagnetic radiation module may be embedded within the housing.

In another exemplary aspect of the present disclosure, a water filtration assembly is provided. The water filtration assembly may include a filtration housing. The filtration housing may include an end cap. The water filtration assembly may include an electronic module disposed within the filtration housing. The water filtration assembly may include an internal component disposed within the filtration housing. The electronic module may be mounted to the internal component. The end cap may be overmolded over the electronic module and the internal component. A portion of the electronic module is embedded within the end cap.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front view of an embodiment of an appliance according to the present disclosure.

FIG. 2 provides a perspective view of the appliance shown in FIG. 1.

FIG. 3 provides a front view of the refrigerator appliance shown in FIG. 1 with doors in an open position.

FIG. 4 provides a simplified side view of an embodiment of a water filtration assembly secured within an appliance according to the present disclosure.

FIG. 5 provides a simplified internal view of an embodiment of a water filtration assembly according to the present disclosure.

FIG. 6 provides a perspective view of an embodiment of an end cap assembly according to the present disclosure.

FIG. 7 provides a perspective view of an embodiment of an electromagnetic radiation module mounted to top plate according to the present disclosure.

FIG. 8 provides a sectional view of the end cap assembly shown in FIG. 6.

FIG. 9 provides a perspective view of an embodiment of an electromagnetic radiation module according to the present disclosure.

FIG. 10 provides a perspective view of an embodiment of an electromagnetic radiation module according to the present disclosure.

FIG. 11 provides a perspective view of an embodiment of an end cap assembly according to the present disclosure.

FIG. 12 provides a perspective view of the end cap assembly of FIG. 11.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components or systems. For example, the approximating language may refer to being within a 10 percent margin (i.e., including values within ten percent greater or less than the stated value). In this regard, for example, when used in the context of an angle or direction, such terms include within ten degrees greater or less than the stated angle or direction (e.g., “generally vertical” includes forming an angle of up to ten degrees in any direction, such as, clockwise or counterclockwise, with the vertical direction V).

The word “exemplary” is used herein to mean “serving as an example, instance, or illustration.” In addition, reference to “an embodiment” or “one embodiment” does not necessarily refer to the same embodiment, although it may. Any implementation described herein as “exemplary” or “an embodiment” is not necessarily to be construed as preferred or advantageous over other implementations.

Except as explicitly indicated otherwise, recitation of a singular processing element (e.g., “a controller,” “a processor,” “a microprocessor,” etc.) is understood to include more than one processing element. In other words, “a processing element” is generally understood as “one or more processing element.” Furthermore, barring a specific statement to the contrary, any steps or functions recited as being performed by “the processing element” or “said processing element” are generally understood to be capable of being performed by “any one of the one or more processing elements.” Thus, a first step or function performed by “the processing element” may be performed by “any one of the one or more processing elements,” and a second step or function performed by “the processing element” may be performed by “any one of the one or more processing elements and not necessarily by the same one of the one or more processing elements by which the first step or function is performed.” Moreover, it is understood that recitation of “the processing element” or “said processing element” performing a plurality of steps or functions does not require that at least one discrete processing element be capable of performing each one of the plurality of steps or functions.

Generally, the present disclosure is directed to water filtration assemblies, and more particularly to water filtration assemblies having improved construction. In particular, in certain embodiments, the water filtration assemblies of the present disclosure include a filtration housing, an electronic module disposed within filtration housing, and an internal component disposed within the filtration housing. The electronic module being mounted to the internal component. The filtration housing can include an end cap that is overmolded over the electronic module and the internal component, for instance, to fluidly isolate the electronic module.

Notably, embodiments of the present disclosure provide a water filtration assembly and methods of manufacturing the same that advantageously protect power consuming components positioned within the filtration housing. For instance, portions of the filtration housings, such as an end cap, are overmolded over top of power consuming components positioned within the filtration housing. As the power consuming components and electrical connectors thereof are embedded in plastic (e.g., via the overmolding process), the power consuming components are advantageously protected from water within the water filtration assembly. Thus, electrical faults at the electrical components can advantageously be prevented.

Additionally or alternatively, the water filtration assembly, and the method for manufacturing the same, provided in the present disclosure advantageously lowers manufacturing cost of water filtration assemblies (e.g., when compared to manufacturing costs of existing water filtration assembly). For example, by overmolding the electrical components in plastic, the water filtration assembly, and the methods for manufacturing the same, advantageously reduce or mitigate part count of the water filtration assembly by eliminating the need for additional fasteners (e.g., screws, bolts, or the like) that are conventionally used to protect electrical components within existing water filtration assemblies. Thus, manufacturing cost can be kept low as additional fasteners (e.g., screws, bolts, or the like) are no longer needed.

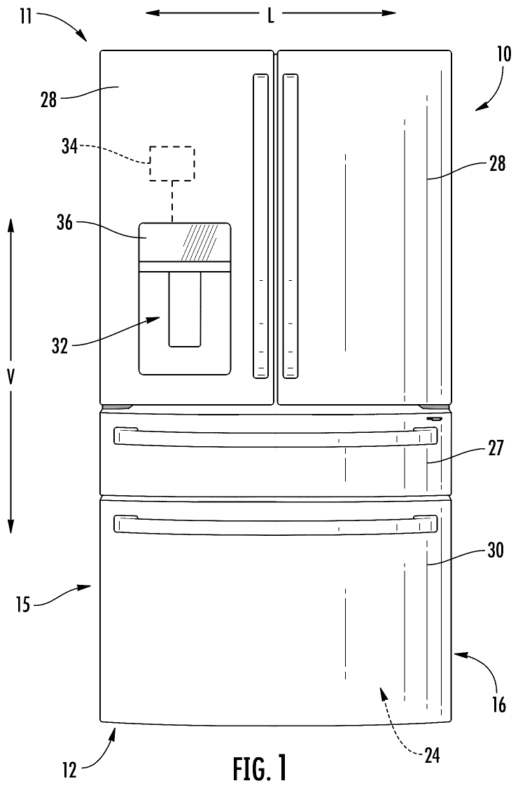

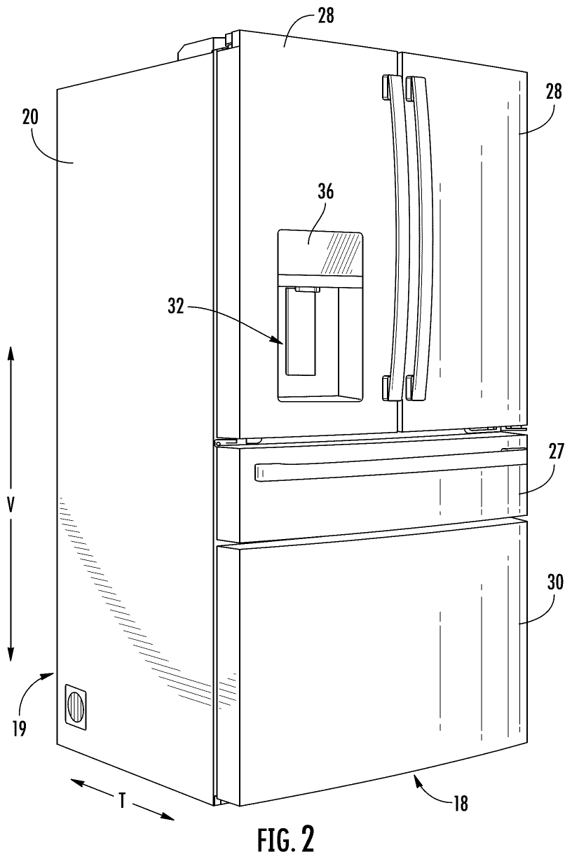

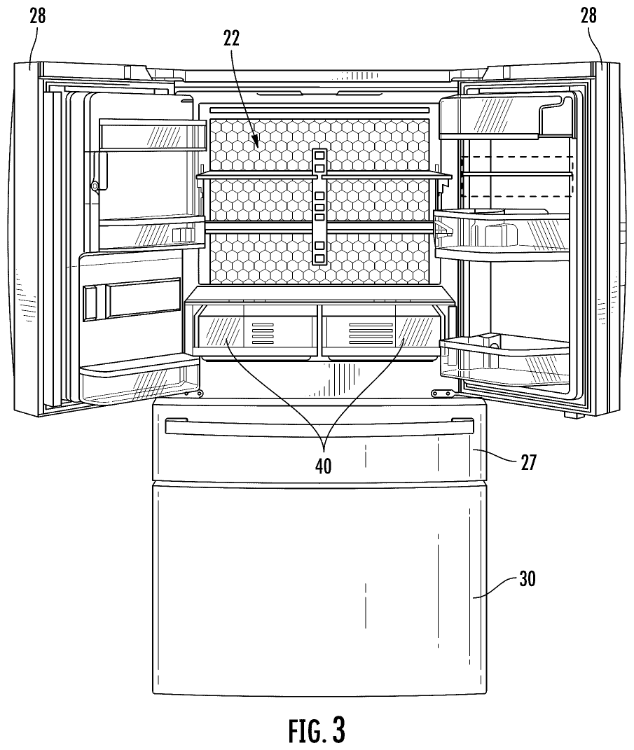

Referring now to the drawings, FIG. 1 illustrates a front view of an embodiment of a refrigerator appliance 10 according to the present disclosure. FIG. 2 illustrates a perspective view of the refrigerator appliance 10. FIG. 3 illustrates a front view of the refrigerator appliance 10 with refrigerator doors 28 in an open position. FIG. 1, in particular, illustrates the refrigerator appliance 10 extending between a top 11 and a bottom 12 along a vertical direction V. The refrigerator appliance 10 also extends between a first side 15 and a second side 16 along a lateral direction L. As shown in FIG. 2, a transverse direction T may additionally be defined perpendicular to the vertical and lateral directions V, L. The refrigerator appliance 10 extends along the transverse direction T between a front portion 18 and a back portion 19.

The refrigerator appliance 10 may include a cabinet or housing 20 (FIG. 2) defining an upper fresh food chamber 22 (FIG. 3) and a lower freezer storage chamber 24 arranged below the upper fresh food chamber 22 along the vertical direction V. An auxiliary food storage chamber may be positioned between the upper fresh food chamber 22 and the lower freezer storage chamber 24, e.g., along the vertical direction V. Because the lower freezer storage chamber 24 is positioned below the upper fresh food chamber 22, the refrigerator appliance 10 may be generally referred to as a bottom mount refrigerator. In the embodiment, the housing 20 may also define a mechanical compartment (not shown) for receipt of a sealed cooling system (not shown). Using the teachings disclosed herein, one of ordinary skill in the art will understand that the present technology can be used with other types of refrigerators (e.g., side-by-side) or a freezer appliance as well. Consequently, the description set forth herein is for illustrative purposes only and is not intended to limit the technology in any aspect.

Referring now particularly to FIG. 3, the refrigerator doors 28 may each be rotatably hinged to an edge of the housing 20 for accessing the upper fresh food chamber 22. It should be noted that while two refrigerator doors 28 in a “French door” configuration are illustrated, any suitable arrangement of doors utilizing one, two or more doors is within the scope and spirit of the present disclosure. A freezer door 30 may be arranged below the refrigerator doors 28 for accessing the lower freezer storage chamber 24. In the embodiment, the freezer door 30 is coupled to a freezer drawer (not shown) slidably mounted within the lower freezer storage chamber 24. An auxiliary door 27 may be coupled to an auxiliary drawer which may be slidably mounted within the auxiliary chamber.

Referring back to FIG. 1, operation of the refrigerator appliance 10 can be regulated by a controller 34 that is operatively coupled to a user interface panel 36. The user interface panel 36 may provide selections for user manipulation of the operation of the refrigerator appliance 10 to modify environmental conditions therein, such as temperature selections, etc. In some embodiments, the user interface panel 36 is proximate a dispenser assembly 32. In response to user manipulation of the user interface panel 36, the controller 34 may operate various components of the refrigerator appliance 10. Operation of the refrigerator appliance 10 may be regulated by the controller 34, e.g., the controller 34 may regulate operation of various components of the refrigerator appliance 10 in response to programming or user manipulation of the user interface panel 36.

The controller 34 may include a memory and one or more microprocessors, CPUs or the like, such as general or special purpose microprocessors operable to execute programming instructions or micro-control code associated with operation of the refrigerator appliance 10. The memory may represent random access memory such as DRAM, or read only memory such as ROM or FLASH. In one embodiment, the processor executes programming instructions stored in memory. The memory may be a separate component from the processor or may be included onboard within the processor. It should be noted that controller(s) 34 as disclosed herein are capable of and may be operable to perform any methods and associated method steps as disclosed herein.

The controller 34 may be positioned in a variety of locations throughout the refrigerator appliance 10. In the illustrated embodiment, the controller 34 is located within the refrigerator doors 28. In such an embodiment, input/output (“I/O”) signals may be routed between the controller and various operational components of the refrigerator appliance 10. In one embodiment, the user interface panel 36 represents a general purpose I/O (“GPIO”) device or functional block. In one embodiment, the user interface panel 36 includes input components, such as one or more of a variety of electrical, mechanical or electro-mechanical input devices including rotary dials, push buttons, and touch pads. The user interface panel 36 may include a display component, such as a digital or analog display device designed to provide operational feedback to a user. For example, the user interface panel 36 may include a touchscreen providing both input and display functionality. The user interface panel 36 may be in communication with the controller 34 via one or more signal lines or shared communication busses.

Using the teachings disclosed herein, one of skill in the art will understand that the present disclosure can be used with other types of refrigerators such as a refrigerator/freezer combination, side-by-side, bottom mount, compact, and any other style or model of refrigerator appliance. Accordingly, other configurations of the refrigerator appliance 10 could be provided, it being understood that the configurations shown in the accompanying figures and the description set forth herein are by way of example for illustrative purposes only.

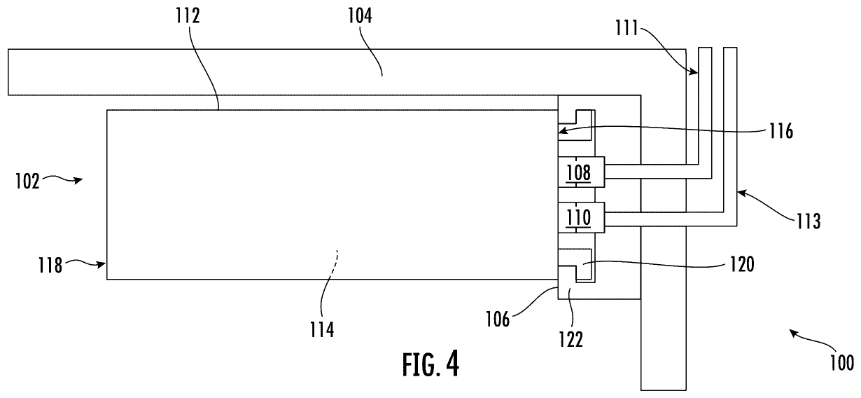

Referring now to FIG. 4, a simplified side view of an embodiment of an appliance 100 having a water filtration assembly 102 according to the present disclosure is illustrated. In particular, as shown, the appliance 100 includes at least one wall 104 having a manifold 106 secured thereto. Furthermore, the appliance 100 generally includes a water source (not shown) that provides water to and from the water filtration assembly 102, e.g., through the manifold 106 via a water inlet 108 and a water outlet 110. In addition, as shown, the appliance 100 may include supply and return tubes 111, 113 fluidly coupled to the water inlet 108 and water outlet 110, respectively.

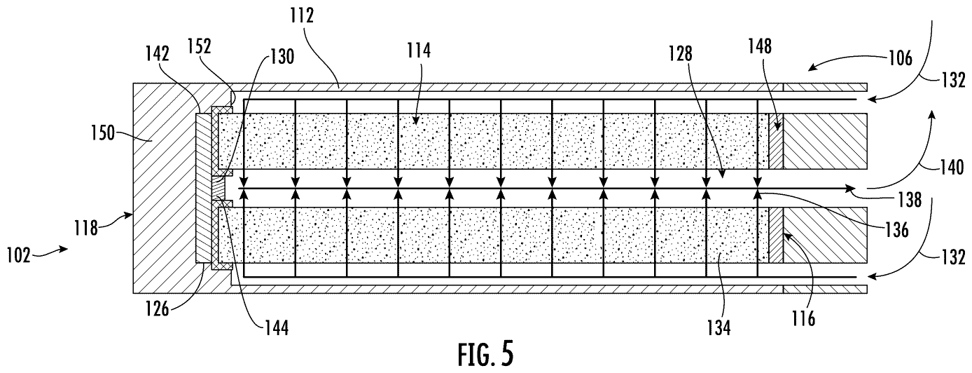

Referring to FIGS. 4 and 5, the water filtration assembly 102 includes a filtration housing 112 and a filtration media block 114 in fluid communication with the water inlet 108 and the water outlet 110. More specifically, in the illustrated embodiment, the filtration housing 112 includes a first end 116 for securing the water filtration assembly 102 to the manifold 106 and a second end 118 for receiving at least a portion of the components/structures of the water filtration assembly 102. In particular embodiments, as shown in FIG. 4, the first end 116 of the filtration housing 112 may include one or more interlocking features 120 configured to secure the water filtration assembly 102 to corresponding interlocking features 122 of the manifold 106 positioned on the wall 104 of the appliance 100. In further embodiments, the first end 116 of the filtration housing 112 may be secured to the manifold 106 using any suitable means. Furthermore, as shown generally in FIG. 5, the filtration media block 114 may generally have a hollow cylindrical configuration defining a radiation passageway 128.

However, in additional or alternative embodiments, the filtration media block 114 may be configured in any suitable manner such that the filtration media block 114 or an electromagnetic radiation source 126 (e.g., described in more detail below) are capable of treating water within the water filtration assembly 102. For example, in additional or alternative embodiments, the filtration media block 114 may have a square tubular configuration defining the radiation passageway 128. As another example, the filtration media block 114 may have not define a distinct radiation passageway 128. In such embodiments, the filtration media block 114 may be configured as a solid block. Moreover, in such embodiments, the water outlet 110 of the water filtration assembly 102 may be positioned at an opposite the water inlet 108. For instance, in such embodiments, the water outlet 110 and the water inlet 108 may be positioned at opposing sides of the filtration housing 112 such that water may enter and exit the water filtration assembly 102 at opposing sides of the filtration housing 112.

Referring particularly to FIG. 5, the water filtration assembly 102 further includes an electronic module that may be disposed within a surface of the filtration housing 112. In particular, the filtration housing 112 may be overmolded around the electronic module at any suitable location of the filtration housing 112. For example, the filtration housing 112 may be overmolded around the electronic housing at an end cap of the filtration housing, a side wall of the filtration housing, or the like. In this regard, the electronic module may be enclosed, embedded, encapsulated, or otherwise formed within a surface or wall of the filtration housing 112 such that at least a portion of the electronic module is sealed (e.g., from water).

As illustrated in FIG. 5, the electronic module may include or be provided as an electromagnetic radiation module 126. Moreover, as shown, the electromagnetic radiation module 126 includes an electromagnetic radiation source 130 positioned adjacent to the filtration media block 114. As such, in an embodiment, water (as represented by arrows 132 in FIG. 5) is configured to enter the water filtration assembly 102 via the water inlet 108, travel through one or more walls 134 of the filtration media block 114 for treatment (as represented by arrows 136) and into the radiation passageway 128 for further treatment by the electromagnetic radiation (as represented by arrow 138) emitted by the electromagnetic radiation source 130, and exit the water outlet 110 (as represented by arrows 140).

In an embodiment, the filtration media block 114 described herein may be constructed of any suitable material, such as activated carbon (AC). In such embodiments, the adsorptive, catalytic, and structural properties of AC make it effective at capturing contaminants including particulates, volatile organic compounds (VOCs), metals, pharmaceuticals, pharmaceutical break-down products, per- and polyfluoroalkyl substances (PFASs), disinfectants, disinfectant by-products, and other contaminants. In another embodiment, the filtration media block 114 may be constructed of a zeolite, a non-woven material, a textile, an immobilized granulated media, an ion exchange resin, a membrane, a hollow fiber, or a composite of natural or synthetic materials.

In another embodiment, the electromagnetic radiation module 126 may be a UVC module 142 and the electromagnetic radiation source 130 may be an electromagnetic radiation emitter 144 that emits germicidal radiation in the ultraviolet-C (UVC) spectrum. For example, the electromagnetic radiation emitter 144 may include (UVC) emitting diode, such as a UV light emitting diode (UV LED), a blue light emitting diode (LED), an ultraviolet-A (UVA) emitting diode, an ultraviolet-B (UVB) emitting diode, or the like.

The water filtration assembly 102 may include a first end cap 148 adjacent to the filtration media block 114 and a second end cap 150 adjacent to the electromagnetic radiation module 126. The second end cap 150 may be secured to the filtration housing 112. In particular, the second end cap 150 may be secured to a bottom edge or wall 152 of the filtration housing 112. As will be appreciated in more detail below, the second end cap 150 may be secured to the bottom edge or wall 152 of the filtration housing 112 via any suitable mechanical coupling means, such as a spin welding process, threads, or the like.

As illustrated in FIG. 5, the second end cap 50 defines a length that is less than (e.g., shorter than) a length of the filtration housing 112. During certain mechanical coupling processes, such as a spin welding process, the shorter second end cap 150 may be coupled to the filtration housing 112. For example, during a spin welding process, the shorter second end cap 150 may be spin welded to the filtration housing 112. However, in additional or alternative embodiments, the filtration housing 112 may may define a length that is less than the length of the second end cap 150. In such embodiments, the filtration housing 112 may be coupled to the second end cap 150. For example, during a spin welding process, the shorter filtration housing 112 may be spin welded to the second end cap 150.

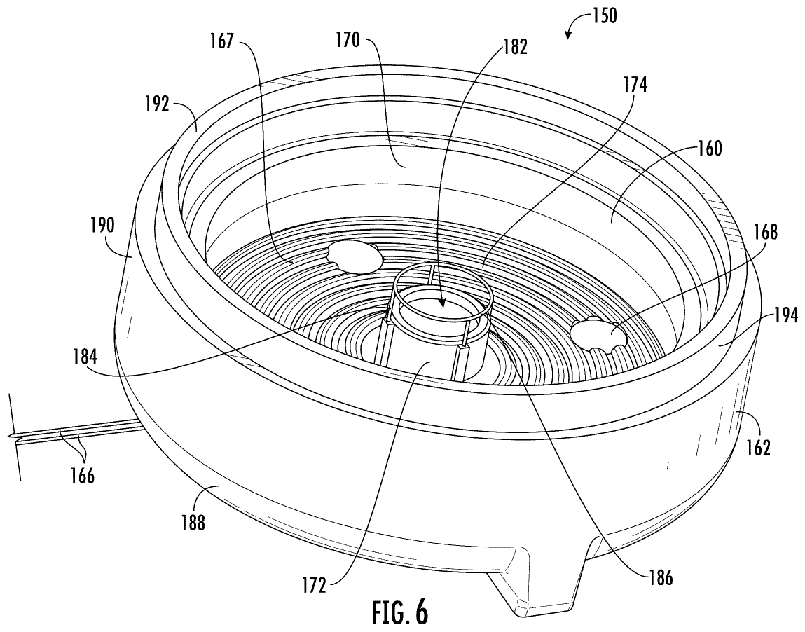

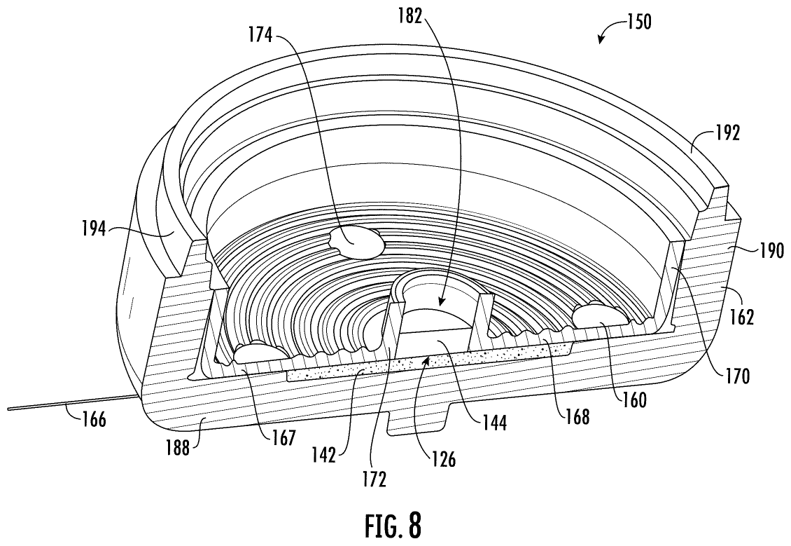

Referring now to FIGS. 6 through 10, embodiments of the second end cap 150 are provided. According to one or more embodiments of the present disclosure, the second end cap 150 may be formed from one or more components. As such, the second end cap 150 may generally be referred hereinafter as the end cap assembly 150. As illustrated, the end cap assembly 150 may include the UVC module 142, a top plate 160, and a housing 162. The UVC module 142 may include a circuit board 164 that may be utilized to electrically couple or connect electrical components to one another in a circuit. In particular, the circuit board 164 may electrically couple the electromagnetic radiation emitter 144 of the UVC module 142 to an electrical body 166. For instance, the electromagnetic radiation emitter 144 may be mounted on or fixed to conductive pads on the outer layer of the circuit board 164, for instance, via soldering. In this regard, the electromagnetic radiation emitter 144 may be electrically coupled and mechanically fastened to the circuit board 164.

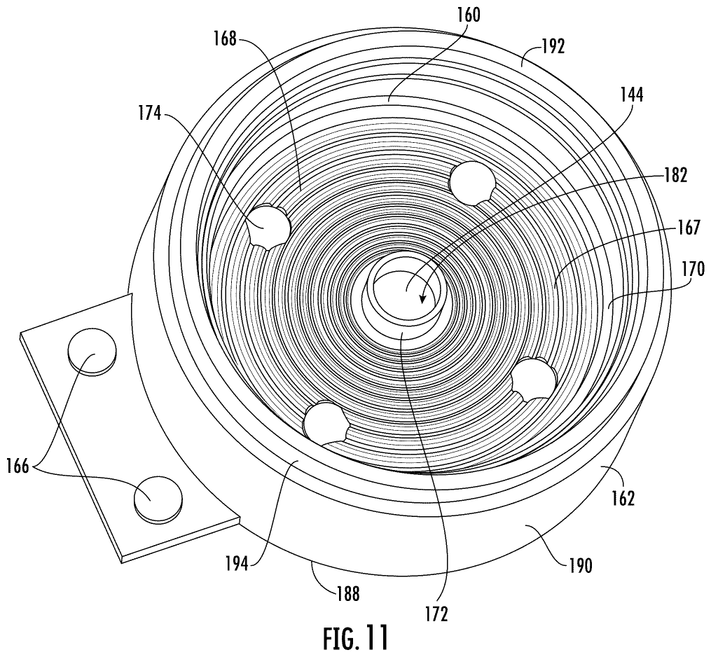

The electrical body 166 may be electrically coupled to the circuit board 164. In particular, the electrical body 166 may be configured to transfer electrical power from an outside power source (e.g., a power source of the refrigerator appliance 10) to the circuit board 164 of the UVC module 142. For example, the electrical body 166 may be or may include one or more electrical wires (FIGS. 6 through 10) electrically coupled to the circuit board 164 of the UVC module 142. As another example, the electrical body 166 may include one or more electrical contact pads (FIG. 11) electrically coupled to the circuit board 164 of the UVC module 142. In such instances, the electrical contact pads provide a conductive surface or area, for instance, outside of the housing 162, for electrical connectors external to the end cap assembly 150 to electrically couple to.

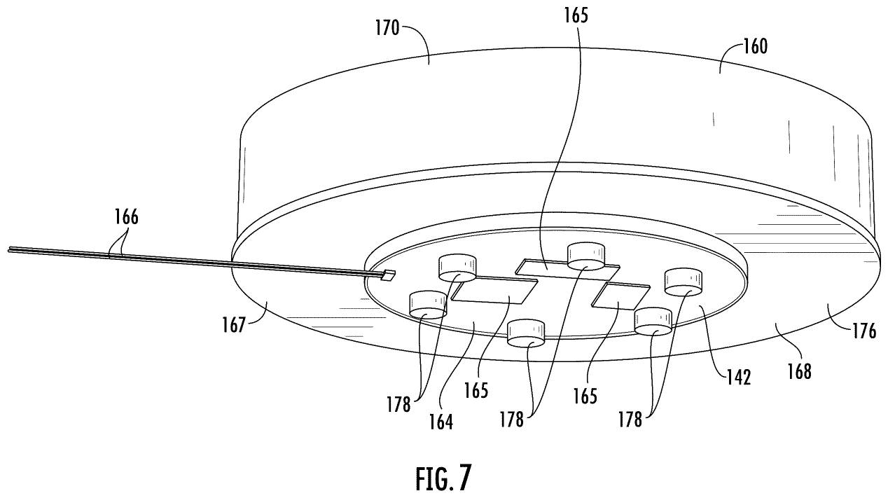

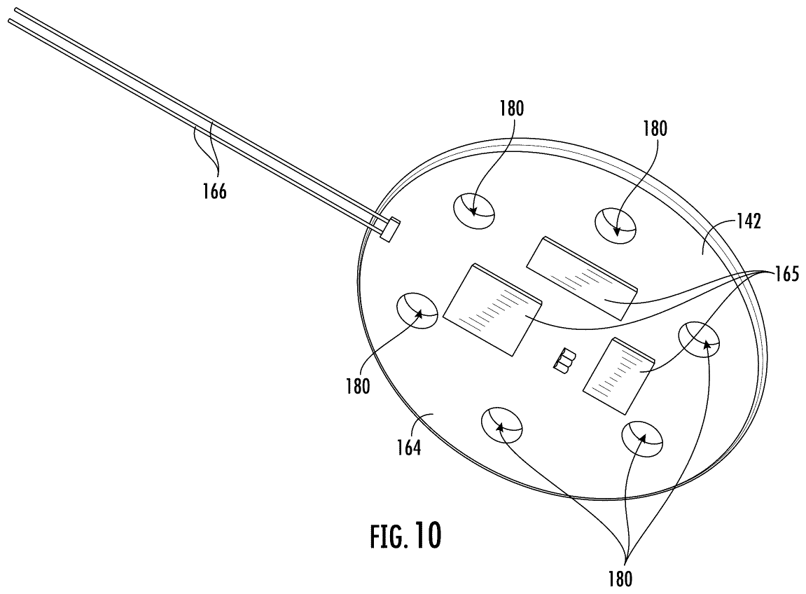

Additionally or alternatively, the UVC module 142 may include one or more sensors 165 (FIGS. 7 and 10) mounted to the circuit board 164. The one or more sensors 165 may include any suitable sensor that may be positioned with the water filtration assembly 102. For example, the one or more sensors may include a turbidity sensor, a temperature sensor, a pressure sensor, a flow rate sensor, a sensor configured to measure electrical current/voltage, or any other suitable sensor.

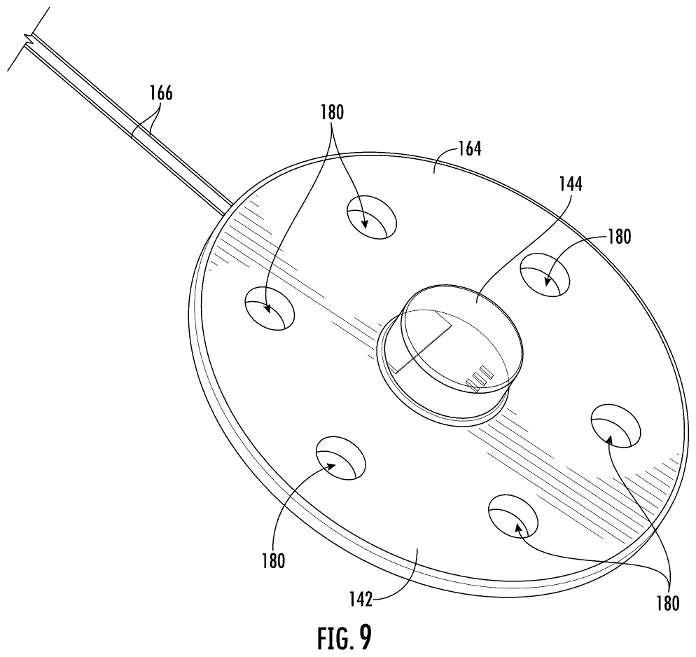

The top plate 160 may be attached to a portion of the filtration media block 114. In particular, the top plate 160 may be attached to an end portion of the filtration media block 114 may be attached to a bottom wall 167 of the top plate 160, for instance, when the end cap assembly 150 is secured to the filtration housing 112. As will be appreciated in more detail below, the top plate 160 may be mounted or molded (e.g., compression molded) to the UVC module 142. The top plate 160 may include a base 168, an outer rim 170, and a light housing 172. The base may include a top face 174 and a bottom face 176. The bottom face 176 may include one or more connection bodies 178 (FIG. 7) protruded therefrom. The connection bodies 178 may engage with one or more apertures 180 (FIGS. 9 and 10) defined through the circuit board 164, for instance, to mount the circuit board 164 to the bottom face 176 of the top plate 160.

During the construction of the water filtration assembly 100, the top plate 160 may be molded to the circuit board 164. In particular, the material, such as polymer material, of the top plate 160 may be overmolded to the circuit board 164. During the overmolding process, a portion of the material of the top plate 160 may be pushed (e.g., extruded) through the apertures 180 to form the extruded shape of the connection bodies 178. The connection bodies 178 may define a “tapered” or a “mushroomed” shape as a result of the overmolding process. In such instances, the connection bodies 178 advantageously mechanically fasten the circuit board 164 to the top plate 160. Notably, such mechanically fastening of the circuit board 164 to the top plate 160 reduces material cost and assembly times (e.g., when compared to existing methods of securing an electrical component within a filtration housing).

The outer rim 170 of the top plate 160 may be extended from the base 168 of the top plate 160. In particular, the outer rim 170 may be extended from an outer circumferential edge of the base 168. The light housing 172 may also be extended from the base 168. In particular, the light housing 172 may be extended from a center portion of the base 168. The light housing 172 may be positioned radially inward of the outer rim 170. The light housing 172 may define a light opening 182 that the electromagnetic radiation emitter 144 may be housed within. In particular, the light housing 172 may be a hollow wall, such as a hollow cylindrically shaped wall, a hollow square shaped wall, a hollow diamond shaped wall, or the like that defines the shape of the light opening 182. Moreover, the light housing 172 may align with the radiation passageway 128 defined by the filtration media block 114 when the end cap assembly 150 is secured to the filtration housing 112. In this regard, electromagnetic radiation (as represented by arrow 138 in FIG. 5) emitted by the electromagnetic radiation emitter 144 may treat water within the radiation passageway 128.

Additionally, the end cap assembly 150 may include a protection body 184 arranged adjacent to the electromagnetic radiation emitter 144 to protect (e.g., fluidly isolate) the electromagnetic radiation emitter 144 from water within the water filtration assembly 102. As illustrated in FIG. 6, the protection body 184 includes a lens 186. The lens may be mounted to the light housing 172 above the electromagnetic radiation emitter 144. The lens 186 may be made of borosilicate glass, polycarbonate, or another suitable material transparent to the wavelength of the electromagnetic radiation from the electromagnetic radiation emitter 144. In this regard, the lens 186 is configured to isolate the electromagnetic radiation emitter 144 from water within the filtration housing 112. In addition, the lens 186 may be designed to modify the direction of the electromagnetic radiation rays. For example, the lens 186 may be configured to reduce the rays into a narrow beam and, consequently increase the radiation intensity within the radiation passageway 128.

In additional or alternative embodiments, the protection body 184 may include a protective coating material. The protective coating material may include any suitable material that may be configured to coat or cover the electromagnetic radiation emitter 144 and areas within the light housing 172 surrounding the electromagnetic radiation emitter 144 such that the electromagnetic radiation emitter 144 is protected (e.g. fluidly isolated) from water within the water filtration assembly 102. For example, the protective coating material may include a polymer based coating, such as a silicone coating, that may fluidly isolate the radiation emitter 144 while also allowing UV light to pass through coating.

The housing 162 may be overmolded over the UVC module 142 and the top plate 160 via an overmolding process. The overmolding process may refer to a process wherein UVC module 142 and the top plate 160 are covered (e.g., partially or fully) by the housing 162. For example, during the overmolding process, a material that forms the housing 162 is injection molded over the UVC module 142 and the top plate 160 to create an enclosed, protected, and functional assembly. In particular, the housing 162 may be overmolded over the UVC module 142 and the top plate 160 to protect and organize the electrical components (e.g., the circuit board, the electromagnetic radiation emitter 144, the electrical bodies 166, or the like) of the UVC module 142. For example, the electrical components may be embedded (e.g., fully or partially) within the material that forms the housing 162 following the overmolding process.

The housing 162 may include a base 188 and an outer rim 190. The outer rim 190 may be extended from the base 188. In particular, the outer rim 190 may be extended from a circumferential edge of the base 188 of the housing 162 to form an opening for the UVC module 142 and the top plate 160 to be disposed in. The outer rim 190 of the housing 162 may include a connection body 192. As illustrated, the connection body 192 may be extended from an upper edge of the outer rim 190. In addition, the connection body 192 may be inset from the outer rim 190. In this regard, the housing 162 may be secured to the filtration housing 112 at the connection body 192. For example, the connection body 192 may include a flat outer surface 194 that is engaged with an inner wall of the filtration housing 112. As will be appreciated in more detail below, the flat outer surface 194 of the connection body may be spin welded to the inner wall of the filtration housing, for instance, to secure the end cap assembly 150 to the filtration housing 112.

In additional or alternative exemplary embodiments, the connection body 192 may include any suitable connection means. For example, the connection body 192 may include a threaded body. In such instances, the filtration housing 112 may include a complimentary threaded body that the connection body 192 may threadedly engage with, for instance, to secure the housing 162 to the filtration housing 112.

In some embodiments, the base 188 defines a heat opening 196 therethrough. The heat opening 196 may define any suitable shape therethrough. For example, as illustrated, the heat opening 196 may be a circular opening defined through the base 188. In such instances, the end cap assembly 150 further includes a heat sink body 198 positioned within the heat opening 196. The heat sink body 198 may be interfaced (e.g., directly or indirectly) with the UVC module 142 to control thermal characteristics of the UVC module 142 during operation of the UVC module 142. The heat sink body 198 may include any suitable device or material that may be configured to control thermal characteristics of the UVC module 142. For example, the heat sink body 198 may include or be configured as a heat exchanger that may absorb heat from the UVC module 142, for instance, during operation of the UVC module 142. As another example, the heat sink body 198 may include any suitable metal material (e.g., aluminum, copper, or the like) that has a relatively high thermal mass (e.g., an ability to absorb, store, and release heat) that may absorb heat from the UVC module 142, for instance, during operation of the UVC module 142.

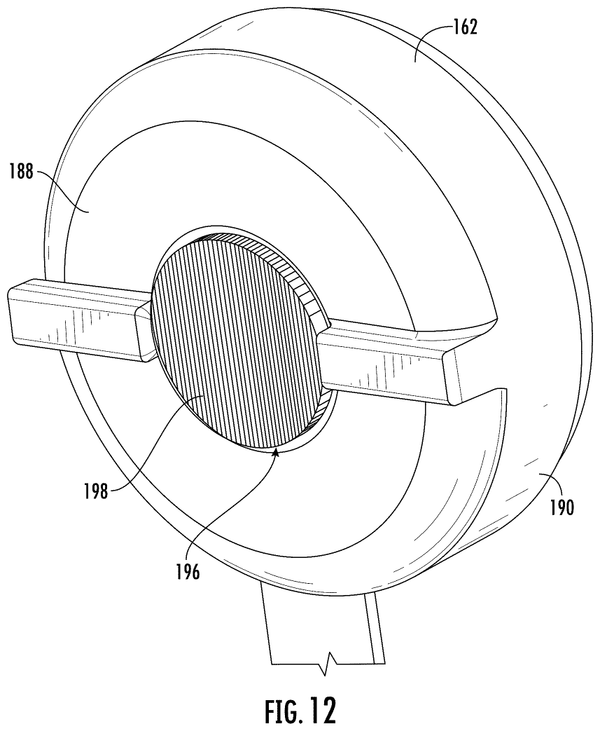

In further embodiments, the present disclosure is directed to a method of manufacturing a water filtration assembly. Thus, FIG. 13, illustrates a flow diagram of an embodiment of a method 200 for manufacturing a water filtration assembly according to the present disclosure. In general, the method 200 is described herein with reference to the water filtration assembly, components of the water filtration assembly, and the appliance illustrated in FIGS. 4 through 12. However, it should be appreciated that the disclosed method may be implemented with any water filtration assembly and appliance having any other suitable configurations. In addition, although FIG. 13 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, or adapted in various ways without deviating from the scope of the present disclosure.

At 210, the method 200 includes mounting an electronic module of the water filtration assembly to an internal component of the water filtration assembly positioned within a filtration housing. The electronic module may include a self-contained electrical unit that serves a specific function within the water filtration assembly. For example, the electronic module may include an electromagnetic radiation module (e.g., a UVC module) that generally includes a circuit board, an electrical body (e.g., electrical wires, electrical contact pads, or the like) electrically coupled to the circuit board, or an electromagnetic radiation emitter electrically coupled to the electrical body via the circuit board. In particular, the electromagnetic radiation emitter may emit germicidal radiation via at least one of an UVC emitting diode, a blue light emitting diode (LED), an ultraviolet-A (UVA) emitting diode, or an ultraviolet-B (UVB) emitting diode.

The internal component of the water filtration assembly may include any non-electrical component disposed within the water filtration assembly. For example, the internal component may include a filtration media, and more particularly, a top plate of the filtration media, utilized for the treatment of water. In such instances, the filtration media may include at least one of an activated carbon (AC) block, a zeolite, a non-woven and textile block, an immobilized granulated media, an ion exchange resin block, a membrane, a hollow fiber, or a composite block. The electronic module may be mounted to the internal component via one or more connection bodies of the internal component being disposed and secured within one or more apertures defined through the electronic module.

At 220, the method 200 includes overmolding (e.g., via an overmolding process) a housing over the electronic module and the internal component. The overmolding process may include injection molding the material that forms the housing over the electronic module and the internal component. For example, the housing may be constructed from a plastic material, such as polypropylene plastic, polyvinyl chloride, or the like. The plastic material may be injected molded over the electronic module and the internal component of the water filtration assembly to cover (e.g., partially or fully) the electronic module and the internal component of the water filtration assembly. During the overmolding process, the housing may create an enclosed, protected, and functional assembly for the water filtration assembly. In particular, electrical components, such as electrical wires, electrical contact pads, or the like, of the electrical module may be embedded within the plastic material of the housing. In this regard, the electrical components may be protected from water within the water filtration assembly. For example, the housing may be overmolded over the UVC module and the top plate to form an end cap assembly for the water filtration assembly (e.g., as described in greater detail above).

At 230, the method 200 includes securing the housing to a filtration housing. For instance, the housing having the electronic module and the internal component mounted thereto, may be secured to the filtration housing. For example, a connection body of the housing may be secured to the filtration housing. In some instances, the connection body may be welded to the filtration housing, for instance, via a spin welding procedure. Thus in some embodiments, securing the housing to the filtration housing may include welding, with a spin welding procedure, the housing to the filtration housing. The spin welding procedure may include applying an axial force to the housing (e.g., to or toward the filtration housing) while rotating the housing against a stationary filtration housing. The resulting friction generates heat that melts the connection body at the interface between the connection body and the filtration housing. Thus, forming a welded assembly.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A water filtration assembly for an appliance, the water filtration assembly comprising:
a filtration housing; and
an end cap assembly secured to the filtration housing, the end cap assembly comprising:
an electromagnetic radiation module comprising an electromagnetic radiation source,
a top plate, the electromagnetic radiation module being mounted to the top plate, the top plate comprising a light housing defining a light opening, the electromagnetic radiation source being positioned within the light opening, and
a housing disposed over the electromagnetic radiation module and the top plate,
wherein a portion of the electromagnetic radiation module is embedded within the housing.

2. The water filtration assembly of claim 1,further comprising:
a filtration media, the filtration media comprising at least one of an activated carbon (AC) block, a zeolite, a non-woven and textile block, an immobilized granulated media, an ion exchange resin block, a membrane, a hollow fiber, or a composite block,
wherein the filtration media is attached to the top plate.

3. The water filtration assembly of claim 1, wherein the electromagnetic radiation source is an electromagnetic radiation emitter that emits germicidal radiation via at least one of an ultraviolet-C (UVC) emitting diode, a blue light emitting diode (LED), an ultraviolet-A (UVA) emitting diode, or an ultraviolet-B (UVB) emitting diode.

4. The water filtration assembly of claim 1, wherein the electromagnetic radiation module comprises a circuit board,
wherein the electromagnetic radiation source is mounted and electrically coupled to the circuit board.

5. The water filtration assembly of claim 4, further comprising:
an electrical body electrically coupled to the circuit board,
wherein the electromagnetic radiation source is electrically coupled to the electrical body via the circuit board, and
wherein the electrical body is embedded, at least in part, within the housing.

6. The water filtration assembly of claim 5, wherein the electrical body comprises one or more electrical wires.

7. The water filtration assembly of claim 5, wherein the electrical body comprises one or more electrical contact pads.

8. The water filtration assembly of claim 1, wherein the top plate comprises base and an outer rim extended from an outer circumferential edge of the base, and
wherein the light housing is extended from the base and is positioned radially inward of the outer rim.

9. The water filtration assembly of claim 8, wherein the electromagnetic radiation module defines one or more apertures therethrough,
wherein the base of the top plate comprises one or more connection bodies,
wherein the connection bodies are protruded from a bottom face of the base of the top plate, and
wherein the connection bodies are disposed within the apertures and are configured to secure the electromagnetic radiation module to the top plate.

10. The water filtration assembly of claim 1, wherein the top plate comprises a protection body at the light housing configured for fluidly isolating the light opening.

11. The water filtration assembly of claim 10, wherein the protection body comprises a lens mounted to the light housing above the electromagnetic radiation source.

12. The water filtration assembly of claim 1, wherein the housing comprises a base and an outer rim extended from the base,
wherein the base defines a heat opening therethrough, and
wherein the water filtration assembly further comprises a heat sink body disposed within the heat opening.

13. The water filtration assembly of claim 12, wherein the heat sink body is interfaced with a bottom face of the electromagnetic radiation module.

14. The water filtration assembly of claim 13, wherein the heat sink body comprises a metal material configured for absorbing heat from the electromagnetic radiation module.

15. The water filtration assembly of claim 12, wherein the outer rim of the housing comprises a connection body,
wherein the housing is secured to the filtration housing at the connection body.

16. A water filtration assembly comprising:
a filtration housing;
an electronic module disposed within a surface of the filtration housing;
an internal component disposed within the filtration housing, the internal component configured for treating water within the filtration housing,
wherein the filtration housing is overmolded over at least a portion of the electronic module.

17. The water filtration assembly of claim 16, wherein the electronic module comprises an electrical body and a power consuming component,
wherein the power consuming component is electrically coupled to a power source via the electrical body,
wherein the power source is external to the water filtration assembly, and
wherein the electrical body is embedded within the filtration housing.

18. The water filtration assembly of claim 16, wherein internal component comprises a filtration media,
wherein the filtration media comprises at least one of an activated carbon (AC) block, a zeolite, a non-woven and textile block, an immobilized granulated media, an ion exchange resin block, a membrane, a hollow fiber, or a composite block.

19. The water filtration assembly of claim 16, wherein the electronic module comprises an electromagnetic radiation source,
wherein the electromagnetic radiation source is an electromagnetic radiation emitter that emits germicidal radiation via at least one of an ultraviolet-C (UVC) emitting diode, a blue light emitting diode (LED), an ultraviolet-A (UVA) emitting diode, or an ultraviolet-B (UVB) emitting diode.

20. The water filtration assembly of claim 16, wherein the filtration housing comprises an end cap,
wherein the end cap is overmolded over at least a portion of the electronic module,
wherein the end cap comprises a connection body, and
wherein the connection body of the end cap is secured to the filtration housing via a spin welding process.
